(19) United States
(12) Patent Application Publication
(10) Pub. No.: US 2026/0205274 A1
(43) Pub. Date: Jul. 16, 2026

(54) SYSTEM AND METHOD FOR PRIVACY-PRESERVING FEDERATED ACCOUNTABILITY COORDINATION ACROSS INDEPENDENT DISTRIBUTED COMPUTATIONAL GOVERNANCE DOMAINS

(71) Applicant: Michael Duane Cooper, Eagle, ID (US)

(72) Inventor: Michael Duane Cooper, Eagle, ID (US)

(21) Appl. No.: 19/564,833

(22) Filed: Mar. 12, 2026

(51) Int. Cl. H04L 9/08; H04L 9/30; H04L 9/32

(52) U.S. Cl. CPC H04L 9/0825; H04L 9/085; H04L 9/30; H04L 9/3247

(57) ABSTRACT

A system and method for coordinating accountability records across independent organizational governance domains in distributed computing environments. Gateway nodes maintain independent accountability systems including mandate records, receipt records, verification outcomes, and tamper-evident audit chains. Hub nodes coordinate cross-boundary mandates using privacy-preserving state projection that maps Gateway lifecycle states to a reduced coordination model using only cryptographic commitments, state identifiers, and digital signatures, never accessing underlying criteria or evidence. The system provides forward-secret criteria transfer through untrusted relays via ephemeral key exchange, end-to-end settlement signal signing with relay co-signatures, peer-to-peer Hub federation without mandatory central authority, cross-organizational reputation aggregation with anti-gaming measures, and Gateway revocation with broadcast propagation. A three-tier architecture (Standalone, Gateway, Hub) enables additive federation upgrade without data migration or schema changes.

### CROSS-REFERENCE TO RELATED APPLICATIONS

This application claims the benefit of U.S. Provisional Application No. 64/003,331, filed Mar. 12, 2026, under 35 U.S.C. § 119(e), which is hereby incorporated by reference in its entirety.

This application is related to the following co-pending U.S. Provisional Applications by the same inventor, each of which is hereby incorporated by reference in its entirety:

U.S. Provisional Application No. 63/999,660, entitled “System and Method for Maintaining Data Integrity in Hierarchical Multi-Agent Task Verification,” which describes the cascading verification mechanism that produces outcomes propagated across federation boundaries by the present invention.

U.S. Provisional Application No. 63/999,669, entitled “System and Method for Application-Layer Tamper-Evident Audit Chain Maintenance with Per-Record Chain Isolation, Transactional State-Change Atomicity, and Regulatory Compliance Integration,” which describes the tamper-evident audit chain architecture maintained independently at each federation node and whose integrity is preserved across cross-boundary coordination.

U.S. Provisional Application No. 63/999,674, entitled “System and Method for Automated Compliance Verification of Task Attestations Using Schema-Driven Structural Validation and Criterion-Specific Tolerance Comparison,” which describes the two-phase verification engine whose outcomes are relayed across federation boundaries by the present invention.

U.S. Provisional Application No. 63/999,676, entitled “Method and System for Automated Dispute Resolution in Agent Operations via Criterion-Specific Tolerance Expansion and Re-Verification,” which describes dispute resolution mechanisms whose state transitions propagate through the federated coordination system of the present invention.

U.S. Provisional Application No. 63/999,680, entitled “System and Method for Non-Intrusive Behavioral Observation and Accountability Record Generation in Agent Tool-Call Pipelines,” which describes the proxy observation system whose records remain within local governance domains and never cross federation boundaries.

U.S. Provisional Application No. 63/999,683, entitled “System and Method for Automated Cross-Validation of Declared Agent Commitments Against Independently Observed Agent Behavior Using Dual Accountability Trails,” which describes the dual-trail cross-validation mechanism operating within individual governance domains.

U.S. Provisional Application No. 63/999,693, entitled “System and Method for Cross-Platform Multi-Dimensional Performance Assessment of Autonomous Software Agents Using Cryptographically Verified Historical Records,” which describes the reputation scoring system whose outputs are aggregated across federation boundaries by the present invention.

### STATEMENT REGARDING FEDERALLY SPONSORED RESEARCH OR DEVELOPMENT

Not Applicable.

### BACKGROUND OF THE INVENTION

### Field of the Invention

The present invention relates generally to distributed computing systems, and more particularly to systems and methods for coordinating accountability records across independent organizational governance domains in distributed computing environments. The invention addresses problems of privacy preservation, state synchronization, cryptographic key management, settlement signal integrity, and reputation aggregation in federated systems where computational entities—including autonomous software agents, microservices, robotic process automation (RPA) systems, IoT device controllers, enterprise workflow participants, or human-supervised computational processes—operating under different organizational authorities must establish, execute, and verify cross-boundary agreements without exposing proprietary business data to intermediary coordination nodes. The invention is agnostic to the nature of the computational entity; the technical problems and solutions described herein arise whenever independent organizational domains must coordinate accountability records for tasks delegated across domain boundaries.

### Description of Related Art

As computational entities—including autonomous software agents, microservices, robotic process automation bots, IoT device controllers, and enterprise workflow participants—increasingly operate across organizational boundaries, performing procurement, data processing, infrastructure management, and other tasks on behalf of enterprises, a fundamental coordination problem emerges. When Entity A at Organization X delegates work to Entity B at Organization Y, the agreement record (herein “mandate”), the evidence of task completion (herein “receipt”), and the verification outcome must be tracked independently by both organizations while maintaining coordination on shared state transitions such as activation, completion, dispute, and settlement.

Existing approaches to cross-organizational coordination in computing systems fall into two categories, each with critical limitations.

Centralized coordination (e.g., traditional clearinghouse models) requires all parties to submit their data—including business-sensitive acceptance criteria, task evidence, and verification details—to a trusted intermediary. This creates unacceptable privacy exposure for enterprises, particularly in regulated industries subject to data residency requirements (EU GDPR, sector-specific regulations) and competitive sensitivity concerns. Furthermore, it creates a single point of failure and a single point of trust, both of which are architecturally undesirable.

Fully decentralized coordination (e.g., distributed ledger systems) eliminates the trusted intermediary but imposes significant operational overhead: consensus mechanisms, on-chain storage costs, cryptocurrency wallet management, and public data visibility. These requirements are impractical for the HTTP/REST-based enterprise environments where the vast majority of agent operations occur.

There is therefore a need for a coordination mechanism that preserves the privacy guarantees of decentralized systems while providing the operational simplicity of centralized coordination.

The specific technical challenges addressed by the present invention include:

Challenge 1: State Synchronization Without Data Exposure. When two independent governance domains must coordinate on the lifecycle state of a shared agreement (e.g., “has the work been accepted?”, “has verification passed?”), the coordinating intermediary must synchronize state transitions without accessing the underlying mandate criteria or receipt evidence. Existing publish-subscribe and event-driven systems do not address this constraint because they assume the message broker can inspect message content for routing and deduplication.

Challenge 2: Criteria Transfer Through Untrusted Relays. When the principal's governance domain must transmit acceptance criteria to the performer's governance domain, the criteria may traverse one or more intermediary coordination nodes. These nodes must relay the criteria without the ability to decrypt, inspect, or modify them. Standard TLS provides transport-layer encryption but does not prevent the relay node from decrypting at the application layer. Existing message relay systems (email MTA relays, message queue bridges) do not provide application-layer encryption with forward secrecy through untrusted intermediaries.

Challenge 3: Settlement Signal Integrity Through Untrusted Relays. When a verification outcome triggers a settlement recommendation (a signal to a payment platform indicating whether funds should be released or held), this signal traverses the same intermediary coordination nodes. A compromised intermediary could forge, suppress, or modify settlement signals, causing financial harm. Existing message signing schemes provide origin authentication but do not address the specific problem of routing proof (proving the signal traversed a specific path through the federation) combined with origin integrity (proving the signal was not modified in transit).

Challenge 4: Reputation Aggregation from Privacy-Preserving Inputs. When computing cross-organizational reputation scores for agents, the inputs (verification outcomes from individual governance domains) must be aggregated without exposing the details of individual mandates to the aggregating node. Existing federated learning approaches address model parameter aggregation but not the specific problem of accountability reputation scoring from cryptographically signed verification outcomes.

Challenge 5: Symmetric Federation Without Mandatory Central Authority. In deployments involving multiple coordination nodes (herein “Hubs”), any Hub should be able to peer directly with any other Hub without requiring a central registry or root authority. Existing federation protocols (e.g., email SMTP, social media federation protocols) typically assume either a DNS-based discovery model or a central directory, neither of which provides the symmetric peering required for enterprise deployments where organizations may wish to federate directly without third-party involvement.

Challenge 6: Additive Federation Upgrade. An organization operating a standalone accountability system should be able to gain cross-organizational capability by adding configuration parameters alone, without data migration, schema changes, or service interruption. Existing federation systems typically require significant architectural changes to enable federation after initial deployment.

Existing federated systems do not address the specific combination of requirements described above:

Email federation (SMTP/IMAP) provides store-and-forward relay but has no concept of shared state between domains, no settlement signaling, and no reputation aggregation. End-to-end encryption (PGP/S/MIME) exists but does not provide forward secrecy per-message.

Social media federation protocols (ActivityPub, AT Protocol) address content distribution across domains but do not provide bilateral state synchronization, financial settlement signaling, or privacy-preserving reputation aggregation. AT Protocol's DID-based identity model provides self-certifying identifiers but does not address the accountability coordination problem.

Distributed ledger and decentralized consensus systems provide append-only records and consensus but require all participants to share a common data layer, impose cryptocurrency operational overhead, and expose transaction data to all network participants (or require zero-knowledge proofs that add significant computational cost).

Traditional clearinghouse systems (financial settlement, supply chain) centralize data and trust in a single intermediary, creating privacy and single-point-of-failure risks.

Federated learning systems aggregate model parameters across organizational boundaries but do not address accountability records, state synchronization, or settlement signaling.

There is therefore a need for a system and method that enables privacy-preserving coordination of accountability records across independent organizational governance domains, with symmetric peering, forward-secret criteria transfer, end-to-end settlement signal integrity, and anti-gaming reputation aggregation.

### BRIEF SUMMARY OF THE INVENTION

The present invention provides a privacy-preserving federated coordination architecture that enables independent organizational governance domains to synchronize task lifecycle states and settlement outcomes without exposing operational data, mandate criteria, or verification evidence to intermediary coordination nodes. Unlike distributed ledger systems, the invention does not require consensus across all participating nodes, shared ledger storage, or public transaction visibility. The system employs a three-tier deployment architecture (Standalone, Gateway, Hub) where each tier is a strict superset of the previous, enabling additive federation without data migration. Coordination nodes (Hubs) synchronize state transitions between governance domains (Gateways) using only cryptographic hashes, state identifiers, timestamps, and digital signatures—never accessing the underlying mandate criteria, receipt evidence, or audit chain content.

In accordance with the present invention, a method for privacy-preserving federated accountability coordination comprises the following principal mechanisms:

A privacy-preserving state projection mechanism, wherein a coordination node (Hub) maintains a simplified state model comprising six states (OFFERED, ACCEPTED, ACTIVE, COMPLETED, DISPUTED, TERMINAL) that projects from the full sixteen-state lifecycle maintained independently at each governance domain (Gateway). The projection function maps multiple Gateway states to each Hub state, with formally documented information loss. The Hub synchronizes its projected state based on matching reports from both the principal and performer Gateways, advancing its state only when reports from both parties are consistent with the expected transition.

A designated-authority mirror mandate mechanism, wherein each governance domain maintains an independent local mandate record for cross-boundary mandates with field-level authority asymmetrically assigned: the principal Gateway owns metadata fields (criteria, deadline, cancellation rights) while the performer Gateway owns execution fields (receipt evidence, verification state, verification outcome). The Hub enforces this authority model by rejecting state transition reports from the wrong Gateway.

An authenticated criteria transfer mechanism with forward secrecy via untrusted relay, wherein the principal Gateway generates an ephemeral X25519 keypair specific to each mandate, performs Diffie-Hellman key agreement with the performer Gateway's long-term X25519 encryption public key, derives a symmetric session key using HKDF-SHA256, encrypts the criteria using XChaCha20-Poly1305 authenticated encryption, and transmits the ciphertext through the Hub for relay. The ephemeral private key is discarded after encryption, providing forward secrecy.

An end-to-end settlement signal signing mechanism through untrusted relay, wherein settlement signals carry two layers of digital signatures: an origin signature from the originating Gateway using its Ed25519 signing key, and a relay signature from each Hub that relays the signal. A compromised Hub cannot forge the origin signature and can only suppress (not modify) the signal.

A peer-to-peer Hub federation mechanism, wherein any two Hub instances can establish a direct peering relationship without requiring a central registry or root authority, with agent directory synchronization and cross-Hub mandate routing with bounded hop depth.

A cross-enterprise reputation aggregation mechanism with anti-gaming measures, including cross-referencing against Hub state records, intra-enterprise contribution weighting, rate-of-change limits, and minimum sample sizes.

A Gateway revocation and key compromise recovery mechanism, wherein revocation is authenticated by a pre-shared revocation secret independent of the potentially compromised signing key.

A Hub unavailability fail-safe, wherein all pending settlement signals for federated mandates default to HOLD when a Gateway cannot reach its Hub for a configurable timeout period.

An additive federation upgrade path, wherein the system is deployable in three tiers (Standalone, Gateway, Hub), each a strict superset of the previous, enabling upgrade without data migration or schema changes.

### BRIEF DESCRIPTION OF THE DRAWINGS

FIG. 1 is a system architecture diagram showing three deployment tiers (Standalone, Gateway, Hub) with data flow boundaries.

FIG. 2 is a privacy boundary diagram showing data that crosses federation boundaries (hashes, state identifiers, signatures) versus data that remains within Gateway domains (criteria, evidence, audit chain content).

FIG. 3 is a sequence diagram of the ephemeral key exchange for forward-secret criteria transfer through an untrusted Hub relay.

FIG. 4 is a diagram of the dual-signature settlement signal flow showing origin signature (Gateway) and relay signature (Hub) through single-hop and multi-hop topologies.

FIG. 5 is a diagram of the state projection function mapping sixteen Gateway states to six Hub coordination states.

FIG. 6 is a diagram of the cross-boundary mandate lifecycle showing designated authority assignment (principal owns metadata, performer owns execution) with Hub state synchronization.

FIG. 7 is a diagram of the peer-to-peer Hub federation topology showing direct peering, agent directory synchronization, and multi-hop mandate routing with bounded depth.

FIG. 8 is a sequence diagram of the Gateway revocation protocol showing revocation request, broadcast to peered Hubs, and fail-safe HOLD on revoked settlement signals.

FIG. 9 is a diagram of the reputation aggregation flow showing anonymized contributions from Gateways, cross-referencing against Hub state records, and anti-gaming weighting.

### DETAILED DESCRIPTION OF THE INVENTION

The following detailed description refers to the accompanying drawings. Like reference numerals refer to like elements throughout. The description is illustrative and not limiting, the scope of the invention being defined by the appended claims.

### Terminology

As used herein, “task specification record” (referred to in specific implementations as a “mandate”) means a structured data record comprising acceptance criteria, tolerance parameters, deadline constraints, and identifying information for a principal and a performer, against which task completion is measured. “Attestation record” (referred to in specific implementations as a “receipt” or “task attestation”) means a structured data record submitted as evidence of task completion against a task specification record. “Settlement signal” means a machine-readable recommendation (SETTLE, HOLD, or RELEASE) transmitted to a payment or escrow platform indicating the recommended financial disposition of a completed task. These generic terms in the claims encompass any domain-specific implementation that performs the described functions, including but not limited to procurement, data processing, infrastructure management, and autonomous agent orchestration domains.

As used herein, the term “agent” is used as a convenient shorthand for any computational entity that may participate in the federated accountability system. This includes, without limitation, autonomous software agents communicating via agent-to-agent protocols, microservices responding to API calls, robotic process automation (RPA) bots, IoT device controllers, enterprise workflow participants, and human-supervised computational processes. The specific nature of the computational entity is immaterial to the federation coordination mechanisms described herein; the term “agent” should not be construed as limiting the invention to any particular type of computational entity.

### System Architecture

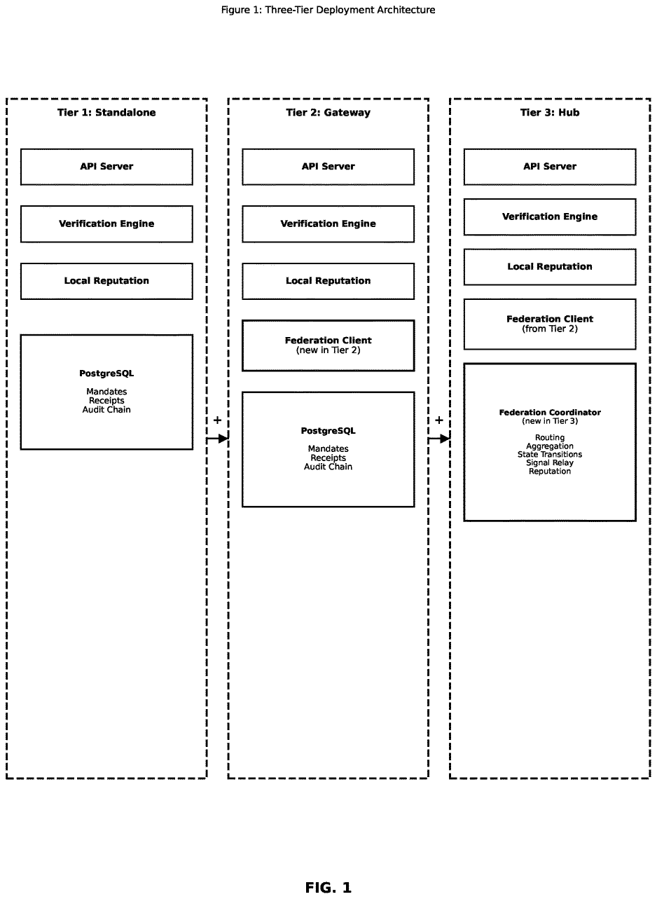

Referring now to FIG. 1, in a preferred embodiment, the system comprises a plurality of Gateway nodes, each operating within an independent organizational domain, connected to one or more Hub nodes that provide coordination services. Each Gateway maintains a complete, independent accountability system including:

A relational data store (PostgreSQL 16+) containing mandate records, receipt records, verification outcomes, and a tamper-evident audit chain as described in co-pending U.S. Provisional Application No. 63/999,669.

A verification engine implementing the two-phase verification process described in co-pending U.S. Provisional Application No. 63/999,674.

A cascading verification system for hierarchical delegation chains as described in co-pending U.S. Provisional Application No. 63/999,660.

Optionally, a proxy observation system as described in co-pending U.S. Provisional Application No. 63/999,680 and dual-trail cross-validation as described in co-pending U.S. Provisional Application No. 63/999,683.

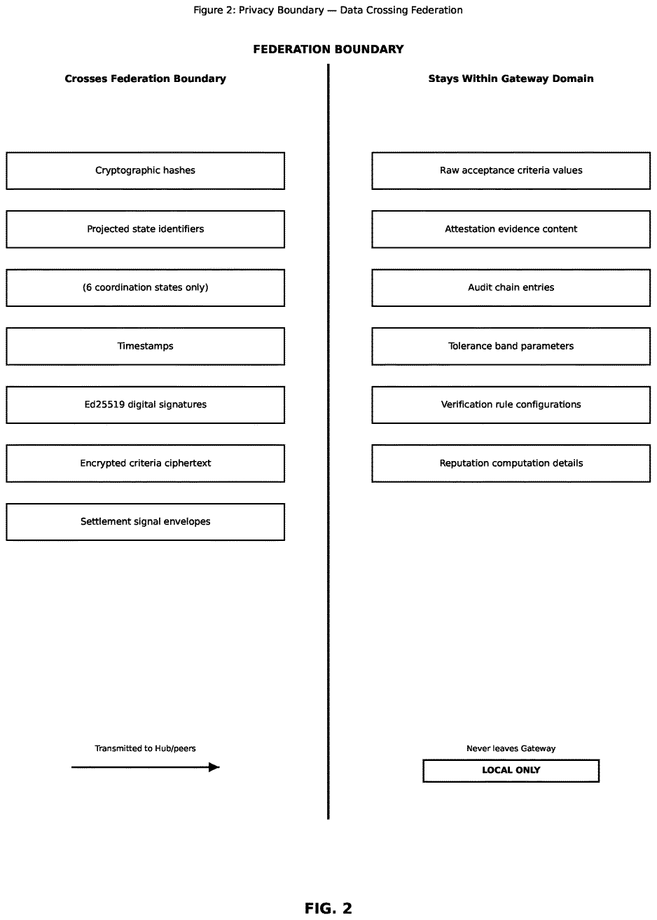

Referring now to FIG. 2, each Hub maintains a separate relational data store containing:

A Gateway registry (federation_gateways): Gateway identifiers, signing and encryption public keys (Ed25519 and X25519 respectively), previous signing keys during rotation grace periods, revocation secret hashes, endpoint URLs, status (active, suspended, revoked), and heartbeat timestamps.

An agent directory (federation_agents): Agent identifiers mapped to their owning Gateway identifiers and declared contract type capabilities.

Federated mandate state (federation_mandates): Mandate identifiers, principal and performer Gateway identifiers, contract type, criteria commitment hash, projected Hub state, last reported Gateway states, verification outcome, settlement signal, and timestamps.

Reputation aggregates (federation_reputation): Agent identifier, contract type, aggregate mandate count, verification count, pass count, contributing Gateway count, composite score, confidence score, and update timestamp.

Reputation contributions (federation_reputation_contributions): Append-only log of per-Gateway reputation contributions with digital signatures, for auditability.

A federation audit log (federation_audit_log): Append-only, hash-chained log of all federation events (Gateway registrations, mandate routing, signal relay, revocations) with optional Ed25519 Hub signatures.

An idempotency table (federation_idempotency): Deduplication of Gateway-to-Hub messages by idempotency key.

### Gateway Registration Protocol

Referring now to FIG. 1, when a Gateway connects to a Hub for the first time, the following protocol executes:

Step 1: The Gateway operator completes an out-of-band identity verification process (e.g., email domain verification, DNS TXT record, manual approval) to establish organizational identity.

Step 2: The Hub issues a one-time registration token associated with the verified identity.

Step 3: The Gateway generates an Ed25519 signing keypair and an X25519 encryption keypair.

Step 4: The Gateway generates a revocation secret (32 bytes, cryptographically random).

Step 5: The Gateway sends a registration request containing: the registration token, the signing public key, the encryption public key, an HMAC-SHA256 hash of the revocation secret, the Gateway's endpoint URL, and a proof-of-possession signature (the request body signed with the Gateway's Ed25519 signing key).

Step 6: The Hub validates the registration token, verifies the proof-of-possession signature, stores the Gateway's credentials, and responds with: the Hub's signing public key, the Hub's encryption public key, and a list of peered Hubs with their public keys.

Step 7: The Gateway stores the Hub's credentials and the peer Hub list.

All subsequent Gateway-to-Hub communication is authenticated via proof-of-possession: every request includes a signature over the request body using the Gateway's Ed25519 signing key, with a timestamp and nonce to prevent replay. This is analogous to the DPoP (Demonstrating Proof of Possession) mechanism defined in RFC 9449, adapted for Ed25519 signatures in a federation context.

### Key Rotation Protocol

Gateway keys can be rotated without re-registration. The Gateway sends a rotation request containing both the old and new public keys, signed by both the old and new private keys (proving possession of both). The Hub accepts both old and new keys for a configurable grace period (default: 24 hours), then drops the old key. The grace period ensures that in-flight messages signed with the old key are not rejected during the transition.

### State Projection Function

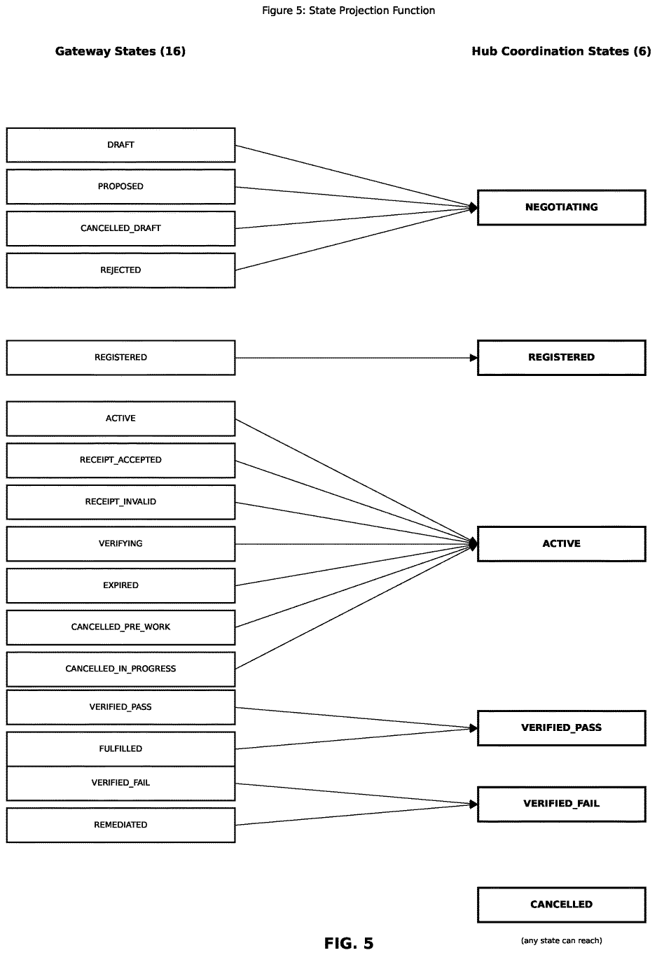

Referring now to FIG. 5, the Hub projects Gateway states to a simplified six-state model using the following function:
projectToHubState(gatewayState): DRAFT, PROPOSED, REGISTERED maps to OFFERED (pre-activation); ACTIVE, RECEIPT_ACCEPTED, RECEIPT_INVALID maps to ACTIVE (work in progress); VERIFYING maps to ACTIVE (still in progress); VERIFIED_PASS, FULFILLED maps to COMPLETED (success path); VERIFIED_FAIL, REMEDIATED maps to COMPLETED (failure path); DISPUTED (any) maps to DISPUTED; EXPIRED, CANCELLED_DRAFT, CANCELLED_PRE_WORK, CANCELLED_IN_PROGRESS, REJECTED maps to TERMINAL.

Information loss is inherent and acknowledged: the Hub cannot distinguish retry cycles (RECEIPT_INVALID to RECEIPT_ACCEPTED) or dispute overturns (VERIFIED_FAIL to VERIFIED_PASS via dispute resolution). This information loss is acceptable because the Hub's function is coordination, not forensics. Each Gateway's local audit chain retains the complete state history.

### Privacy-preserving State Projection Mechanism

Referring again to FIG. 5, the Hub's state record for each cross-boundary mandate comprises: a mandate identifier, principal and performer Gateway identifiers, a contract type identifier, a cryptographic commitment to the mandate criteria (computed by the originating Gateway using a blinded commitment scheme), the projected Hub state, the last reported Gateway states, verification outcome, settlement signal, and timestamps. The Hub never stores, accesses, or can derive the actual mandate criteria or receipt evidence.

### Designated-Authority Mirror Mandates

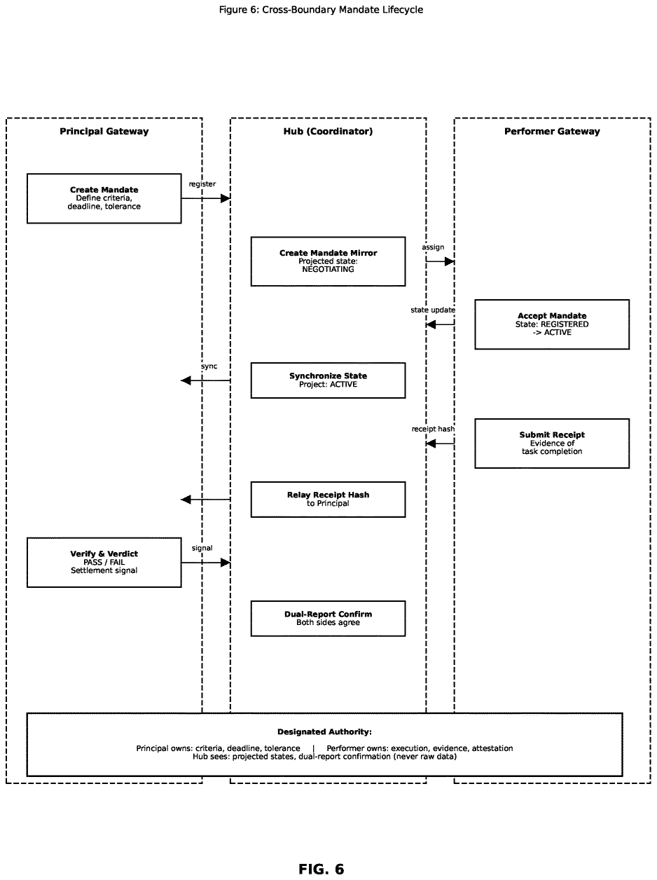

Referring now to FIG. 6, when a mandate spans two governance domains, each domain maintains an independent local mandate record—a “mirror mandate.” Field-level authority is asymmetrically assigned: the principal Gateway owns metadata fields (criteria, deadline, cancellation rights) while the performer Gateway owns execution fields (receipt evidence, verification state, verification outcome). The Hub enforces this authority model by rejecting state transition reports from the wrong Gateway (e.g., rejecting a CANCELLED report from the performer Gateway, rejecting a VERIFIED_PASS report from the principal Gateway).

This designated-authority model prevents split-brain divergence—a class of consistency failure in distributed systems where two nodes each believe they have authority to mutate the same state, producing irreconcilable records.

When a dispute is filed against a task specification record at the performer Gateway, the performer Gateway reports the dispute state transition to the Hub. The Hub projects this to its DISPUTED coordination state and notifies the principal Gateway that the mandate has entered a disputed state. The Hub does not relay the dispute details (e.g., the specific criteria at issue or the dispute rationale) —only the projected state change. The principal Gateway's local mandate record is updated to reflect the dispute without exposing the performer's dispute evidence to the coordination node.

### Authenticated Criteria Transfer with Forward Secrecy via Untrusted Relay

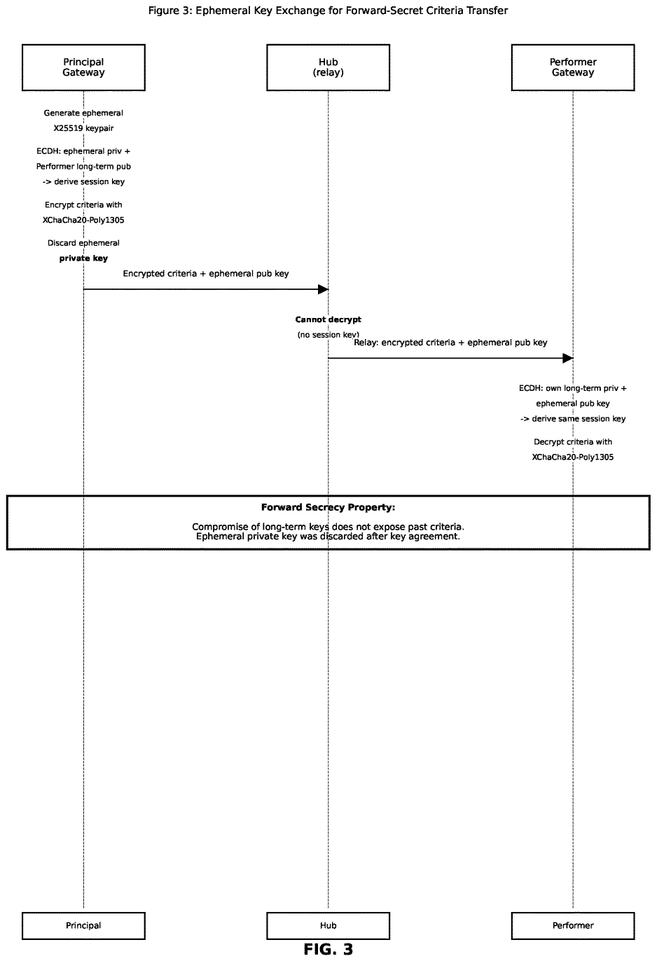

Referring now to FIG. 3, when the principal Gateway must transmit mandate criteria to the performer Gateway, it performs the following steps:
(a) Generate an ephemeral X25519 keypair specific to this mandate.
(b) Perform Diffie-Hellman key agreement between the ephemeral private key and the performer Gateway's long-term X25519 encryption public key.
(c) Derive a symmetric session key using HKDF-SHA256 from the shared secret.
(d) Encrypt the criteria using XChaCha20-Poly1305 (an authenticated encryption with associated data construction) with the derived session key. The plaintext includes: mandate identifier, nonce, timestamp, sender Gateway identifier, recipient Gateway identifier, and the criteria content.
(e) Transmit the ciphertext along with the ephemeral public key (in cleartext) to the Hub for relay.
(f) Discard the ephemeral private key.

The Hub relays the encrypted envelope to the performer Gateway. The performer Gateway derives the same session key using its long-term X25519 private key and the received ephemeral public key, decrypts the criteria, and verifies all envelope fields to prevent replay attacks.

This mechanism provides forward secrecy: compromise of either Gateway's long-term encryption key does not retroactively expose previously transferred criteria, because the ephemeral private key used for each mandate has been discarded. This is an application of the Noise NK pattern (one-way authenticated key exchange) to the specific problem of criteria transfer through untrusted intermediaries.

### End-to-End Settlement Signal Signing through Untrusted Relay

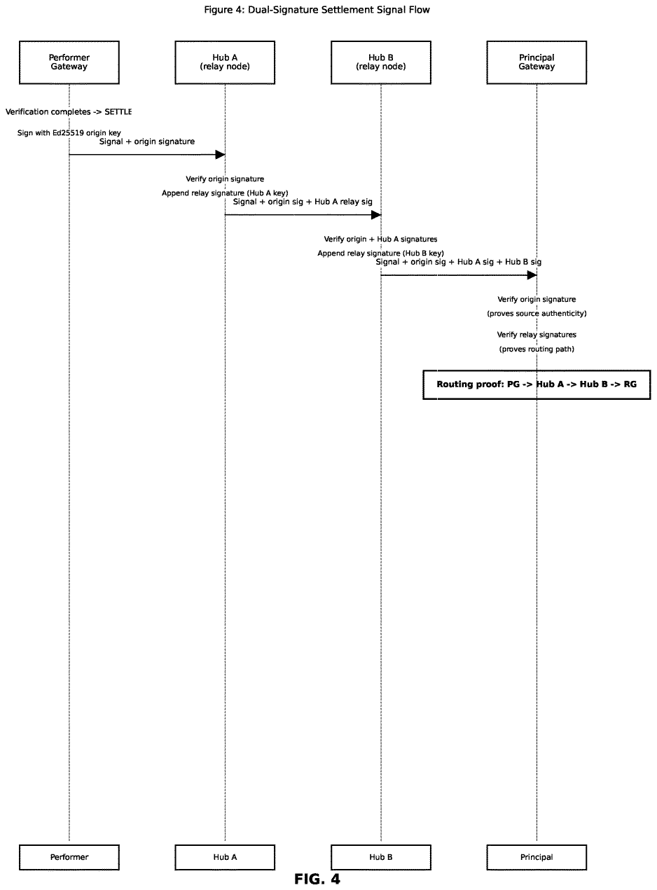

Referring now to FIG. 4, when the performer Gateway's verification engine produces a settlement recommendation (SETTLE, HOLD, or RELEASE), the signal is transmitted to the principal Gateway through one or more Hub nodes. The signal carries two layers of digital signatures:
(a) Origin signature: The originating Gateway signs the settlement signal (comprising mandate identifier, signal type, verification outcome reference, and timestamp) using its Ed25519 signing key. This signature is verifiable by the receiving Gateway using the originator's public key, which was exchanged during federation registration.
(b) Relay signature: Each Hub that relays the signal co-signs the relay envelope (comprising the origin-signed signal, the relay timestamp, and the receiving Gateway identifier) using its own Ed25519 signing key. This provides routing proof—cryptographic evidence that the signal traversed a specific coordination node.

The receiving Gateway verifies the origin signature directly, confirming the signal was produced by the claimed originating Gateway. The relay signature provides an additional non-repudiation property: the Hub cannot later deny having relayed the signal. Critically, a compromised Hub cannot forge the origin signature, because it does not possess the originating Gateway's Ed25519 private key. The Hub can suppress a signal (fail to relay it), but the Hub unavailability fail-safe (described below) addresses this by defaulting to HOLD when the Hub is unreachable.

For settlement signals traversing multiple Hubs (multi-hop routing), each Hub in the path adds its own relay signature, creating a chain of relay proofs. The receiving Gateway verifies all signatures to confirm the complete routing path.

### Peer-to-Peer Hub Federation

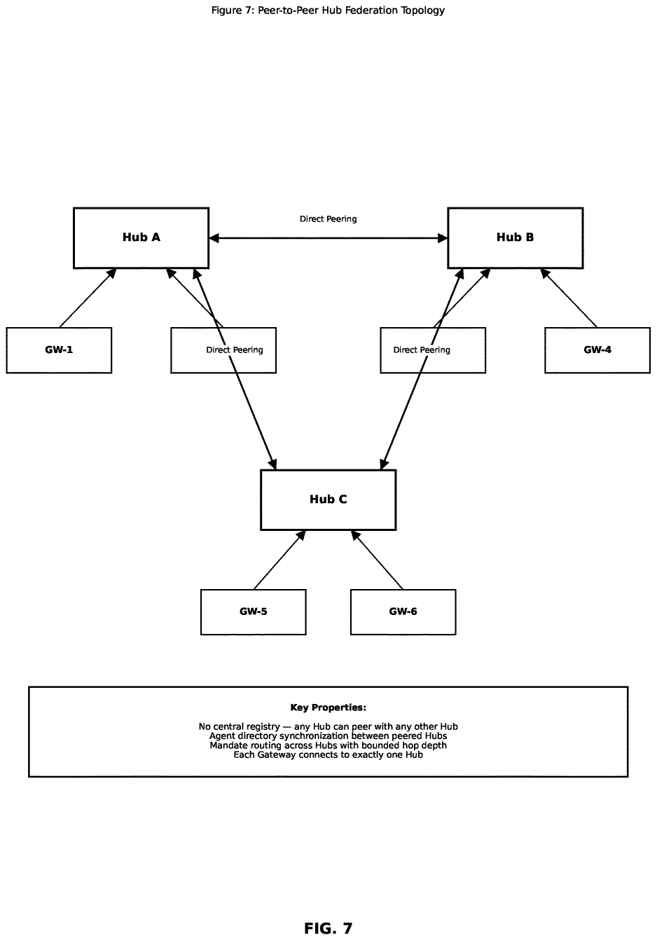

Referring now to FIG. 7, any two Hub instances can establish a direct peering relationship without requiring a central registry, root authority, or mandatory intermediary. The peering protocol comprises:
(a) Mutual registration: Hub A sends a registration request to Hub B containing its signing public key, encryption public key, endpoint URL, and a proof-of-possession signature. Hub B validates the proof-of-possession and, if accepted, responds with its own keys and a signed acknowledgment. Both Hubs store each other's credentials.
(b) Agent directory synchronization: Each Hub maintains a directory of agents registered at its connected Gateways. When a peering relationship is established, Hubs exchange agent directory summaries (agent identifiers and declared contract types only—no operational data). When a Gateway at Hub A seeks an agent registered at Hub B, Hub A queries Hub B's agent directory via the peering API.
(c) Cross-Hub mandate routing: When a mandate's principal is registered at Hub A and the performer is registered at Hub B, the mandate offer is routed Hub A to Hub B to the performer's Gateway. Both Hubs maintain projected state records for the mandate. State transitions from each Gateway are relayed through their respective Hubs to the peer Hub.
(d) Multi-hop routing with bounded depth: To prevent routing loops and unbounded relay chains, cross-Hub routing is limited to a configurable maximum hop depth (default: 2). Each relay message carries a hop counter that is decremented at each Hub. Messages arriving at a Hub with hop counter zero are rejected with a routing depth error.

This mechanism enables a deployment topology where the software vendor has no architecturally privileged position. An enterprise can operate its own Hub, peer directly with its partners' Hubs, and never route data through the vendor's infrastructure. The vendor's optional managed Hub is one peer among equals, not a mandatory central authority.

### Cross-Enterprise Reputation Aggregation with Anti-Gaming Measures

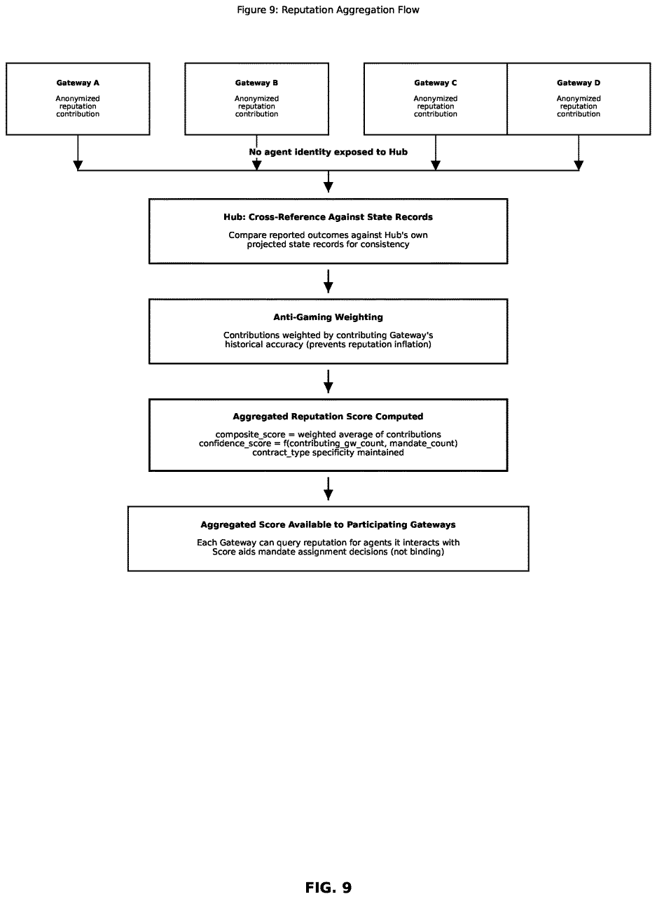

Referring now to FIG. 9, each Gateway periodically contributes anonymized, aggregated verification outcome statistics to its connected Hub(s). Contributions comprise: agent identifier, contract type, reporting period, count of mandates, count of verifications, count of passed verifications, and a digital signature from the contributing Gateway. The Hub aggregates these contributions into a global reputation score per agent per contract type.

Anti-gaming measures include:
(a) Cross-referencing against Hub state records: The Hub compares contributed statistics against its own records of mandate state transitions for the contributing Gateway. Contributions that claim significantly more verifications than the Hub observed state transitions for are flagged for anomaly review.
(b) Intra-enterprise contribution weighting: Contributions from mandates where both principal and performer are registered at the same Gateway (intra-enterprise) are weighted lower than contributions corroborated by cross-enterprise Hub state records, because intra-enterprise mandates are inherently unverifiable by the Hub.
(c) Rate-of-change limits: An agent's reputation score cannot change by more than a configurable threshold per reporting period, preventing sudden reputation inflation.
(d) Minimum sample size: Reputation scores are only published when an agent has accumulated a minimum number of cross-enterprise verifications (default: 10), preventing statistically insignificant data from influencing routing decisions.

### Gateway Revocation and Key Compromise Recovery

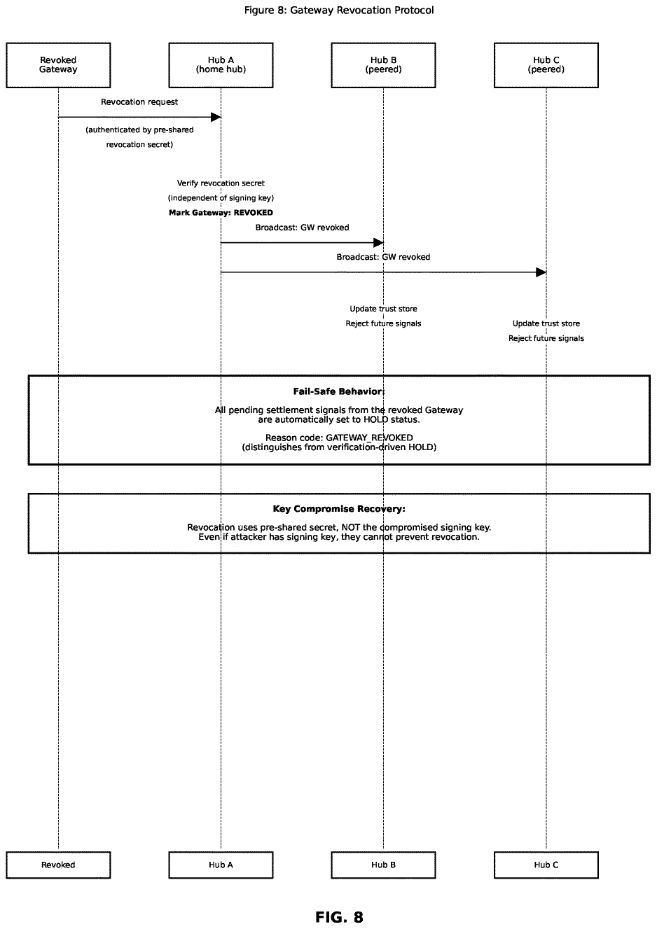

Referring now to FIG. 8, when a Gateway is compromised (not merely key rotation, but full node compromise), the following revocation protocol executes:
(a) The compromised Gateway's operator (or the Hub, upon detecting anomalous behavior) submits a revocation request containing a pre-shared revocation secret established during initial registration. The revocation request is authenticated by the revocation secret, not by the potentially compromised Gateway signing key.
(b) The Hub marks the Gateway as irrevocably revoked and broadcasts the revocation to all peered Hubs.
(c) All Gateways receive revocation notices in their next periodic heartbeat response, which includes a compact revocation list (Gateway identifiers and revocation timestamps).
(d) All nodes reject messages signed by revoked keys. Settlement signals bearing revoked Gateway signatures are automatically treated as HOLD.
(e) In-flight mandates involving the revoked Gateway enter DISPUTED state for manual resolution.

This mechanism addresses the specific problem of key compromise recovery in federated systems where settlement signals have financial consequences. Unlike certificate revocation in TLS (where the risk is unauthorized impersonation), revocation in this system must also address retroactive signal integrity—ensuring that no settlement signal produced by the compromised Gateway after the compromise is accepted.

### Additive Federation Upgrade

Referring again to FIG. 1, the system is deployed in three tiers, each a strict superset of the previous:
(a) Standalone: A complete accountability system operating within a single organizational domain. No federation modules are loaded. All mandates, receipts, verifications, and audit chains are local.
(b) Gateway: A Standalone instance with an additional federation client module enabled via configuration parameters (Hub endpoint URL, Gateway credentials, mode flag). The federation client registers with the Hub on startup, publishes local agent registrations, and relays state transitions for cross-boundary mandates. Existing local mandates are unaffected —only new mandates explicitly marked as federated flow through the Hub. No data migration or schema changes are required. The federation module is additive: it adds columns to existing tables (federated flag, origin Gateway identifier, federation role) with default values that preserve backward compatibility.
(c) Hub: A Gateway instance with an additional federation coordinator module enabled. The coordinator manages Gateway registrations, agent directories, state synchronization, reputation aggregation, and settlement signal relay. A Hub also functions as a Gateway for its own locally registered agents.

This three-tier model enables an organization to begin with a Standalone deployment, upgrade to Gateway when cross-organizational needs arise, and further upgrade to Hub when it wishes to serve as a coordination point for its own ecosystem of partners - all without service interruption, data migration, or schema changes beyond additive column additions.

### Hub Unavailability Fail-Safe

When a Gateway cannot reach its Hub for a configurable timeout period (default: 60 seconds), all pending settlement signals for federated mandates default to HOLD. This fail-safe ensures that Hub unavailability—whether due to network partition, Hub failure, or malicious Hub suppression—results in the conservative financial outcome (funds held pending manual resolution) rather than the permissive outcome (funds released without coordination).

### Cross-Boundary Mandate Flow

Referring now to FIG. 6 in conjunction with FIG. 1, when Agent A (registered at Gateway X, connected to Hub H) offers a mandate to Agent B (registered at Gateway Y, connected to Hub H—or to a peered Hub H2), the following flow executes:
Step 1: Gateway X creates a local mandate record and transmits a mandate offer to Hub H containing: mandate identifier, agent identifiers, contract type, criteria commitment, and Gateway X's signature.
Step 2: Hub H looks up Agent B in its agent directory (or queries a peered Hub's directory). Hub H creates a federated mandate state record with Hub state OFFERED.
Step 3: Hub H relays the mandate offer to Gateway Y (directly, or via peered Hub H2).
Step 4: Gateway Y creates a local mirror mandate record with federation_role set to performer.
Step 5: Gateway X encrypts the mandate criteria using the ephemeral key exchange mechanism described above (see FIG. 3) and transmits the encrypted envelope through Hub H to Gateway Y.
Step 6: Gateway Y decrypts the criteria and activates the local mandate.
Step 7: Both Gateways report state transitions to their Hub(s). The Hub advances its projected state based on consistent reports from both sides.
Step 8: When the performer submits a receipt and verification completes at Gateway Y, the verification outcome (PASS or FAIL, with no evidence content) is reported to the Hub.
Step 9: If the outcome triggers a settlement signal, the performer Gateway signs the signal and transmits it through the Hub to the principal Gateway, using the dual-signature mechanism described above (see FIG. 4).

### Heartbeat and Liveness Detection

Each Gateway sends a periodic heartbeat to its Hub (configurable interval, default: 5 minutes). The heartbeat response includes: the Hub's current time (for clock skew detection), a compact revocation list, and any pending mandate offers or state transition notifications. If a Gateway misses three consecutive heartbeats, the Hub marks it as unresponsive and suspends routing to it. Existing in-flight mandates continue with the last known state until the Gateway reconnects or is manually deregistered.

### Message Idempotency

Every Gateway-to-Hub message carries a unique idempotency key (UUID). The Hub stores processed idempotency keys in a deduplication table with a configurable retention period (default: 72 hours). Duplicate messages are acknowledged without re-processing. This prevents network retries from causing duplicate state transitions, duplicate reputation contributions, or duplicate settlement signal relays.

The Hub returns a signed acknowledgment for every state transition it processes, with a commitment timestamp and the Hub's Ed25519 signature. This provides Gateways with a non-repudiation receipt that the Hub processed their update, analogous to the Signed Certificate Timestamp (SCT) mechanism in Certificate Transparency (RFC 6962).

What is claimed is:

1. A computer-implemented method for coordinating accountability records across independent organizational governance domains in a distributed computing environment, the method comprising:
(a) maintaining, at each of a plurality of governance domain nodes, an independent accountability system comprising task specification records, attestation records, verification outcomes, and a tamper-evident audit chain;
(b) maintaining, at one or more coordination nodes, a projected state model that maps a plurality of governance domain node lifecycle states to a reduced set of coordination states using a state-mapping projection function;
(c) synchronizing the projected state at the coordination node based on signed state transition reports received from both a principal governance domain node and a performer governance domain node, wherein the coordination node advances its projected state only when reports from both parties are consistent with an expected transition; and
(d) wherein the coordination node stores only cryptographic commitments to task specification criteria, state identifiers, timestamps, and digital signatures, and never accesses, stores, or can derive the underlying task specification criteria, attestation evidence, or audit chain content.

2. The method of claim 1, further comprising transferring task specification criteria from the principal governance domain node to the performer governance domain node through the coordination node, wherein:
(a) the principal governance domain node generates an ephemeral asymmetric keypair for each task specification record;
(b) the principal governance domain node performs a key agreement operation between the ephemeral private key and the performer governance domain node's long-term encryption public key to derive a symmetric session key;
(c) the principal governance domain node encrypts the criteria using an authenticated encryption construction with the derived session key;
(d) the ephemeral private key is discarded after encryption;
(e) the coordination node relays the encrypted criteria without the ability to decrypt, inspect, or modify the content; and
(f) the performer governance domain node derives the same session key using its long-term private key and the received ephemeral public key, and decrypts the criteria; whereby compromise of either governance domain node's long-term encryption key does not retroactively expose previously transferred criteria.

3. The method of claim 1, further comprising transmitting settlement signals through the coordination node, wherein:
(a) the originating governance domain node signs the settlement signal using its signing key;
(b) each coordination node that relays the signal co-signs the relay envelope using its own signing key;
(c) the receiving governance domain node verifies the origin signature directly using the originating governance domain node's public key;
(d) a compromised coordination node cannot forge the origin signature and can only suppress the signal; and
(e) when the coordination node is unreachable for a configurable timeout period, pending settlement signals default to a conservative financial outcome.

4. The method of claim 1, wherein the coordination nodes are configured in a peer-to-peer topology, further comprising:
(a) establishing direct peering relationships between any two coordination nodes without requiring a central registry or root authority;
(b) synchronizing agent directory information between peered coordination nodes;
(c) routing cross-boundary task specification offers and state transitions across multiple coordination nodes with a bounded hop depth; and
(d) wherein no coordination node functions as a mandatory central authority, root node, or required intermediary for peering relationships between other coordination nodes.

5. The method of claim 1, further comprising aggregating cross-organizational reputation scores, wherein:
(a) each governance domain node periodically contributes anonymized, aggregated verification outcome statistics signed with the governance domain node's signing key;
(b) the coordination node cross-references contributed statistics against its own records of task specification state transitions for the contributing governance domain node;
(c) contributions from task specification records where both principal and performer are at the same governance domain node are weighted lower than contributions corroborated by cross-organization coordination records; and
(d) reputation score changes are rate-limited per reporting period to prevent sudden inflation.

6. A computer-implemented method for designated-authority cross-boundary task specification management, comprising:
(a) maintaining, at a principal governance domain node, a first task specification record with authority over metadata fields including acceptance criteria, deadline, and cancellation;
(b) maintaining, at a performer governance domain node, a second task specification record for the same logical task specification with authority over execution fields including attestation evidence, verification state, and verification outcome;
(c) maintaining, at a coordination node, a projected state record correlating the two task specification records by a shared task specification identifier; and
(d) wherein the coordination node rejects state transition reports from a governance domain node that does not have designated authority over the field being transitioned; whereby split-brain divergence is prevented by asymmetric authority assignment rather than consensus protocol.

7. The method of claim 1, further comprising a governance domain node revocation protocol, wherein:
(a) a revocation request is authenticated using a pre-shared revocation secret established during initial registration, independent of the potentially compromised signing key;
(b) the coordination node broadcasts revocation to all peered coordination nodes;
(c) all nodes reject messages signed by revoked keys;
(d) settlement signals bearing revoked governance domain node signatures are automatically treated as a conservative financial hold; and
(e) in-flight task specification records involving the revoked governance domain node enter a disputed state for manual resolution.

8. A system for privacy-preserving federated accountability coordination, comprising:
(a) a plurality of governance domain nodes, each comprising a processor, a persistent relational data store, and a network interface, configured to maintain independent accountability records and to transmit signed state transition reports;
(b) one or more coordination nodes, each comprising a processor, a persistent relational data store, and a network interface, configured to receive state transition reports from governance domain nodes, maintain projected state records, relay encrypted task specification criteria and settlement signals, and aggregate reputation contributions;
(c) wherein the coordination nodes store only cryptographic commitments, state identifiers, digital signatures, and aggregate statistics, and never access the underlying task specification criteria, attestation evidence, or audit chain content maintained at the governance domain nodes; and
(d) wherein the system is deployable in a standalone configuration comprising a single organizational domain with no federation modules, a gateway configuration comprising the standalone configuration plus a federation client, or a hub configuration comprising the gateway configuration plus a federation coordinator, with each configuration being a strict superset of the previous, enabling additive upgrade without requiring migration of existing task specification, attestation, or audit data.

9. A non-transitory computer-readable storage medium storing instructions that, when executed by one or more processors coupled to a plurality of networked computing nodes, cause the processors to perform the method of claim 1.

10. The method of claim 1, further comprising each governance domain node transmitting periodic liveness signals to its associated coordination node at a configurable interval, and the coordination node suspending state synchronization for a governance domain node that fails to transmit liveness signals for a configurable number of consecutive intervals.

11. The method of claim 1, wherein each state transition report transmitted from a governance domain node to a coordination node carries a unique idempotency identifier, and the coordination node maintains a deduplication record of processed idempotency identifiers for a configurable retention period, rejecting duplicate reports without re-processing.

12. The method of claim 1, further comprising a governance domain node rotating its cryptographic signing keys by transmitting a rotation request containing both the previous and replacement public keys, signed by both the previous and replacement private keys, and the coordination node accepting signatures from both keys for a configurable grace period before discarding the previous key.

13. The method of claim 6, further comprising, when a dispute is filed against a task specification record in the performer governance domain, projecting the dispute state to the coordination node as a DISPUTED coordination state, and the coordination node notifying the principal governance domain of the dispute without exposing the dispute details.

14. The method of claim 1, further comprising upgrading a computing system initially deployed in a standalone configuration without federation capabilities to a federated configuration by adding network configuration parameters identifying a coordination node, without modifying the existing data schema, migrating existing records, or interrupting service availability.

15. The method of claim 3, wherein the receiving governance domain node verifies the origin signature of a relayed settlement signal against the originating governance domain node's public key obtained during federation registration, independent of any relay signatures, such that a compromised coordination node cannot forge a settlement signal origin.

16. The method of claim 1, wherein the state-mapping projection function maps a plurality of distinct governance domain node lifecycle states to each coordination state in the reduced set, such that the coordination node cannot distinguish between the plurality of governance domain node states that map to the same coordination state, the information loss being an inherent and intentional property of the projection function that prevents the coordination node from inferring operational details of the governance domain nodes beyond the coordination state granularity.
